(19) United States
(12) Patent Application Publication
(10) Pub. No.: US 2019/0389603 A1
(43) Pub. Date: Dec. 26, 2019

(54) Remote Fuel Method of In-space Propulsion

(71) Applicant: Matthew Hal Burch, Columbia, SC (US)

(72) Inventor: Matthew Hal Burch, Columbia, SC (US)

(21) Appl. No.: 16/538,789

(22) Filed: Aug. 12, 2019

Related U.S. Application Data
(63) Continuation-in-part of application No. 14/074,983, filed on Nov. 8, 2013.
(60) Provisional application No. 61/754,535, filed on Jan. 19, 2013.

(51) Int. Cl. B64G 1/24; B64G 1/40

(52) U.S. Cl. CPC B64G 1/242; B64G 1/645; B64G 1/40

(57) ABSTRACT

Disclosed is a hybrid of standard rocketry and beamed power propulsion methods, where in-transit deliveries of fuel are made to in-space payloads on high delta-V missions with time constraints. At least part of the fuel must be accelerated by energy from a source external to the payload, allowing for both rapid acceleration and lower fuel mass ratios.

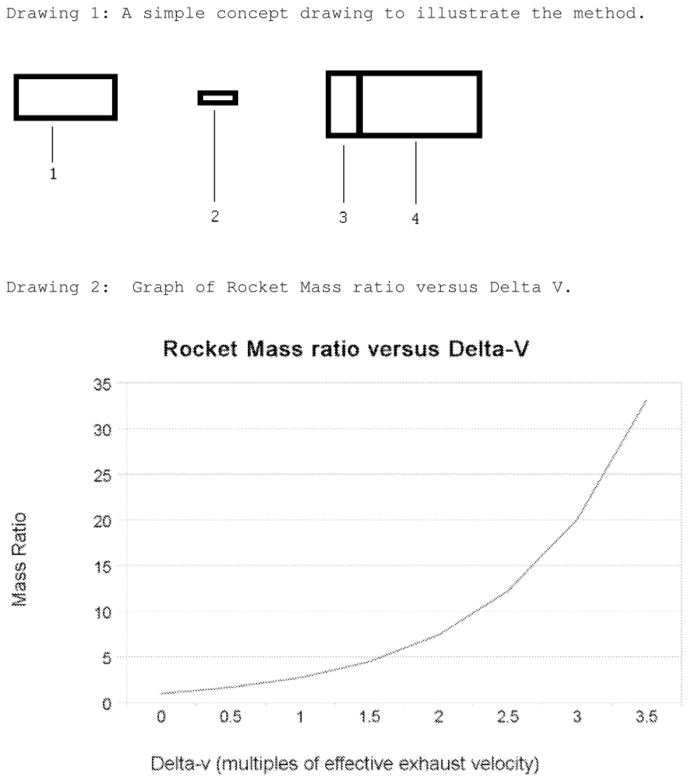

### CROSS-REFERENCE TO RELATED APPLICATIONS

This application is a continuation-in-part of Utility patent application Ser. No. 14/074,983, filed 8 Nov. 2013 by the present inventor, which, in turn, claims the benefit of PPA application No. 61/754,535, filed 19 Jan. 2013 by the present inventor, which are both incorporated by reference herein.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Before any explanations of the method are initiated, definitions and scope should be discussed.

Generally what is described herein is a method of in-space propulsion.

The vast majority of human space activity has been limited to Earth orbit. The reason for this is quite simple. Propulsion methods based on either standard rocketry or beamed power are impractical when there is a need to rapidly generate a great deal of delta-V.

Standard rocketry methods, or methods where the required propulsion energy for a payload is carried as a single mass of fuel, are impractical for high delta-V missions. It does not take long for fuel requirements to become literally impossible to meet as delta-V requirements grow.

Beamed power methods, or methods where most or all of the non-fuel propulsion energy required to move a payload is provided remotely by natural or artificial sources, are impractical for rapid generation of delta-V with existing technologies and space engineering capacity. If time is not a concern, beamed power, especially from natural sources like Earth's sun, become viable without extravagant engineering projects. Unfortunately, time is almost always a concern for missions with crews, or missions that are commercial in nature. If engineering costs are not a concern, extravagantly expensive, immense beamed power transmitters might be built. Unfortunately, human construction on that scale in space is unprecedented. Additionally, costs are almost always a concern—especially costs of space engineering projects larger than anything we have ever built in space at the time of the writing of this document.

Humans in space require many resources to survive. Any long duration mission with live human crew will dramatically increase mission risks and costs. Commercial investment in space missions, with or without crews, must also be measured against the real cost of money over time. The greater the mission duration, the greater the real cost of the mission. This means that extreme duration crewed missions require both extensive crew expenses and very large financial or perceived value returns in order to be commercially viable.

There has been a great deal of research and investment in Earth orbiting systems and how they are supported over time. Orbital systems, like the International Space Station, are in close proximity to a human industrial presence on Earth. There are several methods by which Earth orbital systems can be resupplied at commercially viable costs. If humanity creates an industrial presence on other planets or moons, then variations of the methods used for resupplying Earth orbital systems will surely work just as well for supplying orbiting systems around those other planets and moons, but these methods are not in-space propulsion. Orbital payloads exist in a different environment than extra-orbital payloads, much like Earth upper atmospheric payloads differ from Earth orbital payloads.

Humanity has been modestly invested in Earth orbital operations for decades, but comparatively little has been done outside Earth orbit recently. Humanity obviously must leave Earth before establishing an industrial presence elsewhere. How will humans get from one planet or moon to another, or beyond? How will the asteroid belt be thoroughly explored? What about exploration of Near Earth Objects, comets, or other notable phenomena in space at great distances from current human industrial presences? Described here is an alternate method of propulsion that will allow high delta-V travel, trade, and exploration missions to become more commercially viable.

It is important to understand the differences between methods devoted to resupplying orbital systems around planets, moons, and asteroids, and methods designed to efficiently provide propulsion outside of those ranges.

Orbital systems travel in an arcuate path, remaining relatively close to what they orbit and experiencing gravitational forces that are typically highly regular. Missions outside of the orbits of either planets or moons also follow arcuate paths, but the gravitational forces might be highly irregular. Flyby maneuvers around planets or moons would create arcuate trajectories for missions which only briefly enter a planet or moon's orbital space. The engineering required to compensate for expected variations in gravitational forces will be different for a mission in a near-constant gravitational field sufficient to maintain an orbit, as opposed to a mission with either highly variable or very minor gravitational forces.

Orbital systems, and the equipment used to service them, can be electronically monitored or controlled with relatively little transmission delay from the planet or moon that they orbit, or other orbital systems around the same planet or moon, allowing rapid intervention in near-real-time. Missions that are a greater distance from where mission control is located will need to be designed with greater communication delays in mind.

Every planet and moon will have its own orbital peculiarities, with three potential examples being fringes of atmosphere, additional natural or unnatural orbital bodies, or electromagnetic fields. Other examples certainly exist.

Another critical distinction between orbital resupply missions and missions outside their scope is that there is always an escape velocity from orbit. This means that there is a maximum useful velocity that can be maintained by an object in orbit unless a wasteful secondary acceleration is provided to hold said orbital system in orbit. There is no corresponding maximum velocity for extra-orbital travel, though there may be practical or mission-dependent velocity limits.

While the first implementations of the method would almost certainly originate from Earth or Earth orbit, it is possible to implement the claimed method of propulsion for missions which never enter the orbit of any planet or moon. One example of this could be a long term exploration mission in the asteroid belt, with a launcher system and local fuel source on Ceres.

What is needed in the art is a more efficient method of using fuel to rapidly generate large values of delta-V for long-distance in-space payload delivery.

### BRIEF SUMMARY OF THE INVENTION

The claimed method will be referred to herein as the ‘remote fuel method.’ The remote fuel method can be considered a hybrid of beamed power and standard rocketry methods. Like beamed power methods, a large part of the total energy required by the remote fuel method to accelerate a payload is provided from a source that is disconnected from the accelerated payload. Like standard rocketry methods, physical fuels supply energy used for direct delta-V generation of the accelerated payload. This hybridization of methods allows for both high efficiency and rapid acceleration in missions requiring high values of delta-V.

The remote fuel method allows mission planners to prevent the mass ratio of payloads from growing to a point where extreme fuel inefficiency during active acceleration of a payload is unavoidable. The inefficiency that is intended to be avoided is clearly demonstrated by a graph of fuel mass ratio vs delta-V (Drawing #2). As delta-V requirements grow for a mission being designed under a standard rocketry method, the required fuel mass ratio grows enormously. A 5× mass ratio will ideally provide slightly more than 1.5× effective exhaust velocity in delta-V. To double that delta-V to 3× effective exhaust velocity in an ideal scenario would require the mass ratio to grow to roughly 20×. Using using a single mass of physical fuel to provide additional delta-V beyond 3× effective exhaust velocity quickly becomes implausible under standard rocketry methods, and from there soon becomes impossible due to required fuel masses growing beyond the total mass of the known universe.

With the exception of a possible first fuel mass launched as part of payloads for initial post-launch maneuvering, the remote fuel method accelerates physical fuel to rendezvous in-transit with payloads already in space to provide the energy required for said payloads to generate in-space propulsion. The energy used to accelerate the fuel to meet the payloads is from a source external to the payloads. The mass ratio of fuel to payload for each fuel delivery will vary from mission to mission, and potentially even fuel delivery to fuel delivery, based on mission parameters. Some deliveries might contain negligible or perhaps even no fuel, if a mission calls for that scenario. For missions with large delta-V requirements, keeping mass ratios low while a payload actively accelerates will result in dramatic fuel savings over standard rocketry methods, while avoiding the anemic acceleration rates of beamed power methods.

The remote fuel method is not limited to any specific fuels, technologies, or methodologies for fuel delivery. It is possible to use pure standard rocketry methods or beamed power methods as components of the remote fuel method. How the technologies are used is far more critical than what technologies are used.

### BRIEF DESCRIPTION OF THE SEVERAL VIEWS OF THE DRAWING

There are two drawings:

Drawing 1: A simple concept drawing to illustrate the method.

Drawing 2: Graph of Rocket Mass ratio versus Delta V.

### DETAILED DESCRIPTION OF THE INVENTION

### The First Embodiment

In an exemplary embodiment, a launching system (1) provides initial acceleration for many delivery systems (2). The delivery systems (2) are then collected one at a time by a capture system (3) attached to the payload (4).

The delivery systems (2) utilize their propulsion systems to provide delta-V and orientation changes to the payload (4).

The technologies implemented in the launching system (1) are irrelevant to the definition of the remote fuel method. That said, the technologies chosen for real-world applications certainly impact the efficiency of the method. This embodiment utilizes a solar-powered electromagnetic launching system (1) in orbit around a planet or moon.

The technologies implemented in the delivery systems (2) are irrelevant to the definition of the method. That said, the technology choices chosen for implementation in live missions will certainly impact the efficiency of the remote fuel method. For this embodiment, the delivery systems (2) will carry only fuel as cargo, use an integral communication and tracking system to negotiate with the payload (4) for a low velocity intercept with the capture system (3), use integral propulsion and orientation systems to perform the required intercept maneuvers to align with the capture system (3), and use the integral communication, propulsion, and orientation systems to provide delta-V and orientation control to the payload (4) after being collected by the capture system (3).

As with the other components of the embodiment, the specific technologies chosen to implement the capture system (3) are not required to define the method. Still, the technologies chosen for any given mission would certainly impact the efficiency of the method in real world applications. For this embodiment, the capture system (3) will be attached physically to the payload (4). The capture system (3) will be a mechanical assembly capable of grappling delivery systems (2), and also capable of disconnecting and safely pushing delivery systems (2) out of the way in order to allow subsequent delivery systems (2) to be grappled.

In this embodiment, the payload (4) shall be capable of communicating with the launching system (1), the delivery systems (2), and the attached capture system (3) in order to orchestrate fuel deliveries, including allowing for launching systems (1) and delivery systems (2) to make adjustments on the fly to accommodate potential changes of the in-flight in-space delta-V requirements of the payload (4).

By utilizing multiple delivery systems (2) to deliver multiple small quantities of fuel instead of a large single mass of fuel, the remote fuel method decreases the fuel mass ratio of the payload (4) while it is being accelerated. Decreases in fuel mass ratio, if all other variables are the same, lead to improved propulsive efficiency.

For a mathematical comparison of standard rocketry methods to remote fuel methods, a control is required. The baseline example will be a 100,000 kg payload (4), and will use oxygen and hydrogen as fuel under standard rocketry methods. All of the fuel required will be carried from mission start as a single mass. To reduce complexity, an ideal calculation will be performed. The control will require zero tankage mass, and zero staging mass.

Oxygen and hydrogen as fuel has an ideal exhaust velocity of 4,462 m/s. The mission will require 10,000 m/s of delta-V, accelerating up to 10,000 m/s relative to the launching system (1). An ideal rocket equation calculation follows:

delta-V=(Exhaust Velocity)(Ln(Initial Mass/End mass))

10,000=4,462(Ln(Initial Mass/100,000))

2.241=Ln(Initial Mass/100,000)

2.241=Ln(Initial Mass)−Ln(100,000)

2.241=Ln(Initial Mass)−11.513

13.754=Ln(Initial Mass)

940,343=Initial Mass

Initial mass=payload mass+fuel mass

Fuel mass=(940,343 kg−100,000 kg)=840,343 kg

The fuel mass ratio is roughly 8.4.

Now that a baseline has been generated using standard rocketry methods, a 100,000 kg payload (4) will be considered, utilizing the remote fuel method. A multitude of delivery systems (2) will be accelerated by a launching system (1) and collected by the capture system (3), one at a time. As the delivery systems (2) are grappled, they will expend their fuel to provide delta-V to the payload (4). When empty, the delivery systems (2) will be discarded, in preparation for subsequent delivery systems (2) to arrive and be grappled.

Each of the delivery systems (2) will mass 250 kg. 50 kg will be non-fuel, and 200 kg will be a oxygen and hydrogen fuel mix. This immediately adds a 20 percent tankage mass penalty to the remote fuel method.

As each of the delivery systems (2) connects to the payload (4) and provides delta-V, the payload (4) is accelerated. By the rocket equation, with 4,462 m/s exhaust velocity, 100,250 kg starting mass and 100,050 kg ending mass, there will be an 8.91 m/s delta-V provided by each of the delivery systems (2).

So, 1,123 deliveries of fuel will be required to generate 10,000 m/s delta-V at a rate of 8.91 m/s per each delivery system (2).

1,123 deliveries of 200 kg fuel is 224,600 kg of fuel, as compared to 840,343 kg of fuel required by the standard rocketry method to generate the same delta-V.

That was all of the fuel required, but not all of the energy required. The launching system (1) used energy to accelerate the delivery systems (2). This energy requirement will now be calculated.

The launching system (1) accelerates delivery systems (2) to varying velocities, with each delivery system (2) ideally requiring energy equivalent to (½) (mass) (velocity\hat{ }2). The mass of each of the delivery systems (2) remains constant at 250 kg, but the velocity provided to delivery systems (2) varies from 0 to 9997.02 m/s.

The total energy requirement of the launching system (1) is easily calculated as the sum of a series as follows:

Energy=(½)(mass)(v\hat{ }2)

Energy=125(v\hat{ }2)

V increments from 0 to 9997.02 in 1123 steps of 8.91

Energy=Sum of [125((8.91v)\hat{ }2)] from v=0 to 1122

Energy=4,678,462,246,411 Joules

Energy up to this point has been represented by kilograms of oxygen and hydrogen as fuel, and will continue to be so measured. Each kilogram of oxygen and hydrogen used as fuel is equivalent to 16,000,000 Joules of energy. Therefore the launching system (1) required the energy equivalent of (4,678,462,246,411/16,000,000)=292,404 kg of oxygen and hydrogen fuel mass to accelerate all the delivery systems (2).

The total energy requirement of the remote fuel system for the 10,000 m/s delta-v mission, as measured in units of kilograms of reacting oxygen and hydrogen is now 224,600 kg+292,404 kg=517,004 kg or a fuel mass ratio of 5.17, compared to the standard rocketry method's requirement of 840,343 kg, or a fuel mass ratio of 8.40.

The standard rocketry method required more than 62 percent more fuel than the remote fuel method for the same payload (4)and the same delta-V. It will be noted again that the standard rocketry method was a pure ideal calculation of fuel requirements with no staging or tankage mass, while the remote fuel method included a built-in 20 percent penalty of fuel tankage mass.

The control was intentionally chosen to favor the standard rocketry system, in order to emphasize how much more efficient the remote fuel method is. A more generalized mathematical comparison follows.

Under the embodied remote fuel method, each 250 kg delivery system (2) carrying 200 kg fuel is used by the payload (4) to generate 8.91 m/s delta-V. This is a linear effect.

Under the embodied remote fuel method, the energy required to accelerate the delivery systems (2) of the remote fuel method to the target payload (4) using the launching system (1) will describe a curve defined by the kinetic energy equation, a quadratic function where Joules=(½)(mass)(velocity\hat{ }2).

In the standard rocketry example, the fuel mass ratio requirement when using the standard rocketry method to carry all fuel as a single mass follows an exponential function of the form Fuel Mass Ratio=e\hat{ }N. The equation is simply the rocket equation, rebalanced to solve for fuel mass ratio, as follows:

Start with the rocket equation solved for delta-V

delta-V=(Exhaust Velocity)(Ln(Initial Mass/Final Mass))

(delta-V/Exhaust Velocity)=Ln(Initial Mass/Final Mass)

(Initial Mass/Final Mass)=e\hat{ }(delta-V/Exhaust Velocity)

(Initial Mass/Final Mass)=Fuel mass ratio

Fuel mass ratio=e\hat{ }(delta-V/Exhaust Velocity)

Fuel Mass ratio=e\hat{ }N where N is the ratio of delta-V to Exhaust Velocity.

It is very clear that e\hat{ }N has a much steeper growth curve than the quadratic kinetic energy equation, as demonstrated above. It is also obvious that e\hat{ }N must grow faster than the kinetic energy equation plus a linear equation.

Those skilled in the art will recognize that it is possible to design missions that use delivery systems (2) as launching systems (1) to accelerate other delivery systems (2) as payloads (4), making this propulsion method implementable using current, space-tested technologies.

The efficiency of the remote fuel method is due to utilizing two techniques to avoid severe inefficiencies in propulsive energy utilization. Firstly, fuel is accelerated with energy external to the payloads (4). Secondly, the fuel is utilized in multiple small quantities by the in-transit in-space payload (4), keeping the fuel mass ratio of payloads (4) low while delta-V is being generated.

Those with skill in the art will additionally recognize that the remote fuel method may not offer efficiency greater than that of standard rocketry methods when mission delta-V requirements are low. The point at which the two methods are equally efficient will depend on a number of different variables, including the specific propulsion technologies and fuels chosen. Provided that there is a strong effort to optimize both the remote fuel method and any other extant or possible propulsion methods utilizing comparable technologies, the remote fuel method will become more efficient than standard rocketry methods as delta-V requirements grow.

### The Second Embodiment

In another exemplary embodiment, it would be useful to consider a utilization referenced above, in section 030, where delivery systems can act as launching systems. This implementation could be designed and implemented utilizing existing technologies, and space access infrastructure.

Referring to Drawing 1, the payload (4) will be of X mass. Delivery systems (2) will also be of X mass, and ⅘ of that mass will be fuel. To conceptualize easier, Z is the mass of fuel carried by each delivery system, so Z=4X/5.

The capture systems (3) will consist of electromagnets under flat plates. There shall be one capture system (3) at each end of every delivery system (2), and one on the payload (4).

The launching system (1) will be a series of delivery systems (2) accelerating other delivery systems (2).

After the payload and all delivery systems have been delivered into orbit or space, the first delivery system (2) would connect to the payload (4) via the electromagnetic grapple capture systems (3), and accelerate the payload (4) utilizing its maneuvering engines until exhausting its fuel, imparting a Delta-V of Y.

Once the fuel in the grappled delivery system (2) is used, the polarity of one of the electromagnetic grapples would be reversed, jettisoning the empty delivery system (2). The sum of forces generated by the capture systems (2) during the processes of electromagnetic grappling and jettisoning might provide some minor Delta-V for the payload (4), but will not be included in calculations.

As the payload (4) is being accelerated by the first delivery system (2), the second delivery system (2) will be accelerated by the third delivery system (2) in the same manner.

At this point, both the payload (4) and the second delivery system (2) are both traveling at speed Y, and are near one another in space.

The second delivery system (2) will utilize a tiny fraction of its fuel to initialize a slow docking maneuver with the payload (4).

After the capture systems (3) on the second delivery system (2) and the payload (4) have grappled, the second delivery system (2) will utilize its fuel mass, and provide an additional Y of Delta-V to the payload (4).

So far, one payload (4) of mass X was provided with two separate masses of fuel, generating 2Y Delta-V. The total fuel expenditure was three delivery systems (2) of fuel, or 3Z.

This is not very exciting at first glance. However, it should be carefully noted that if one wants to generate 3Y acceleration for the payload (4) using more delivery systems (2) of fuel, it could be done simply by accelerating the payload (4) and each of the three already mentioned delivery systems (2) utilizing four additional delivery systems.

For each additional Y of Delta-V that one wants to impart to the payload, an additional layer of delivery systems will be required to accelerate the payload and every delivery system required for the next stage.

Y Delta-V used Z fuel. (This is standard rocketry.)

2Y Delta-V used Z+2Z=3Z fuel.

3Y Delta-V uses Z+2Z+4Z=7Z fuel.

4Y Delta-V uses Z+2Z+4Z+8Z=15Z fuel.

5Y Delta-V uses Z+2Z+4Z+8Z+16Z=31Z fuel.

For every additional Y of Delta-V provided to the payload (4), the number of additional delivery systems (2) of fuel required will be the same as the total number of delivery systems (2) required for the last stage, plus one for the payload (4). So, for Q increments of Y Delta-V, ((2\hat{ }Q)−1) delivery systems (2) of fuel will be required in total. 6Y=63Z. 7Y=127Z

Standard rocketry can outperform the remote fuel method for low Delta-V missions, however, under this embodiment, as the Delta-V requirements of a given mission grows, (providing efficiency is pursued strongly under both methods) doubling the number of delivery systems to provide an additional Y of Delta-V begins to grow exponentially more fuel efficient than standard rocketry. After the remote fuel method becomes more efficient than the standard rocketry method, the remote fuel method will rapidly become literally infinitely more efficient than the standard rocketry method, as the standard rocketry method will reach a point where it requires more fuel than the entire mass of the known universe to reach a given delta-V long before the remote fuel method approaches that level of inefficiency.

Modern orbital launch technologies could deliver hundreds or even thousands of small delivery systems (2) and payloads (4) to orbit, allowing for enormous Delta-V generation for small asteroid prospecting, lunar, or planetary probes.

Something like this embodiment of the remote fuel method would also allow for small interstellar probes to be designed, launched, and reach nearby stars within a human lifetime—using today's technology, and not requiring enormous science-fiction-size engineering projects in space.

This embodiment could also easily be the backbone of a system designed deliver munition or kinetic strike payloads in order to protect Earth from Near Earth Orbit asteroids—using today's technology.

1. A fuel-based method of in-space propulsion, comprising:
a) utilizing at least two masses of fuel for in-space post-launch acceleration of a payload (4), with the requirement that at least one of the at least two masses of fuel must be delivered to the payload (4) by at least one delivery system (2) after the payload (4) has experienced in-space acceleration,
b) utilizing at least one launching system (1) to impart delta-V to the at least one delivery system (2) with energy from a source that is not the payload (4),
c) utilizing the at least one delivery system (2), which will be capable of in-flight orientation and velocity corrections, to rendezvous with the payload (4),
d) utilizing a capture system (3) to make fuel, delta-V, or fuel and delta-V from the at least one delivery system (2) available to the payload (4), and
e) utilizing delta-V, fuel, or delta-V and fuel provided by the at least one delivery system (2) to generate delta-V for the payload (4) for in-space propulsion beyond the needs of either orbital stationkeeping or maintaining a consistent relative position in space,
whereby the at least two masses of fuel will be used to generate in-space delta-V for the payload (4) with lower mass ratios than would have been possible if all fuel required for the in-space component of the mission had been carried with the payload (4) throughout the in-space duration of the mission.
